(19) United States
(12) Patent Application Publication
(10) Pub. No.: US 2025/0244801 A1
(43) Pub. Date: Jul. 31, 2025

(54) CONNECTION DEVICE AND ELECTRONIC DEVICE

(71) Applicant: Lenovo (Beijing) Limited, Beijing (CN)

(72) Inventors: Chunfeng YUAN, Beijing (CN); Zhifeng XIN, Beijing (CN); Detao YOU, Beijing (CN); Xu DONG, Beijing (CN)

(21) Appl. No.: 19/033,388

(22) Filed: Jan. 21, 2025

(30) Foreign Application Priority Data
Jan. 31, 2024 (CN) 202410139254.5

(51) Int. Cl. G06F 1/16

(52) U.S. Cl. CPC G06F 1/1681

(57) ABSTRACT

A connection device includes a first rotation assembly including a first connection member, a second rotation assembly rotatably connected to the first rotation assembly and configured to rotate relative to the first rotation assembly to cause relative displacement between a first member and a second member of the second rotation assembly, and a support assembly connected to the first member and the second member. The support assembly includes a second connection member configured to move relative to the first connection member when the second rotation assembly rotates relative to the first rotation assembly.

### CROSS-REFERENCE TO RELATED DISCLOSURE

This application claims priority to Chinese Patent Application No. 202410139254.5, filed on Jan. 31, 2024, the entire content of which is incorporated herein by reference.

### TECHNICAL FIELD

The present disclosure generally relates to the field of electronic device technologies and, more particularly, to a connection device and an electronic device.

### BACKGROUND

When a laptop computer is placed on a desk for use, a display screen is located at a low position. Therefore, a user needs to lower his head to view the display screen, resulting in a poor user experience.

### SUMMARY

In accordance with the disclosure, there is provided a connection device including a first rotation assembly including a first connection member, a second rotation assembly rotatably connected to the first rotation assembly and configured to rotate relative to the first rotation assembly to cause relative displacement between a first member and a second member of the second rotation assembly, and a support assembly connected to the first member and the second member. The support assembly includes a second connection member configured to move relative to the first connection member when the second rotation assembly rotates relative to the first rotation assembly.

Also in accordance with the disclosure, there is provided an electronic device including a first body including an input device, a second body including a display device, and a connection device including a first rotation assembly including a first connection member connected to the first body, a second rotation assembly rotatably connected to the first rotation assembly and configured to rotate relative to the first rotation assembly to cause relative displacement between a first member and a second member of the second rotation assembly, and a support assembly connected to the first member and the second member. The support assembly includes a second connection member connected to the display device and configured to move relative to the first connection member when the second rotation assembly rotates relative to the first rotation assembly.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

FIG. 1 is a schematic structural diagram of a connection device before a second rotation assembly rotates with respect to a first rotation assembly, consistent with embodiments of the present disclosure.

FIG. 2 is a locally enlarged structural diagram of a connection device before a second rotation assembly rotates with respect to a first rotation assembly, consistent with embodiments of the present disclosure.

FIG. 3 is a schematic structural diagram of a connection device after a second rotation assembly rotates with respect to a first rotation assembly, consistent with embodiments of the present disclosure.

FIG. 4 is a locally enlarged structural diagram of a connection device after a second rotation assembly rotates with respect to a first rotation assembly, consistent with embodiments of the present disclosure.

FIG. 5 is a schematic structural diagram of another connection device before a second rotation assembly rotates with respect to a first rotation assembly, consistent with embodiments of the present disclosure.

FIG. 6 is a schematic structural diagram of another connection device after a second rotation assembly rotates with respect to a first rotation assembly, consistent with embodiments of the present disclosure.

FIG. 7 shows an exploded view of a connection device consistent with embodiments of the present disclosure.

FIG. 8 is a schematic partial structural diagram of another connection device before a second rotation assembly rotates with respect to a first rotation assembly, consistent with embodiments of the present disclosure.

FIG. 9 is a schematic partial structural diagram of another connection device after a second rotation assembly rotates with respect to a first rotation assembly, consistent with embodiments of the present disclosure.

FIG. 10 is a schematic structural diagram of an electronic device after a second body rotates with respect to a first body, consistent with embodiments of the present disclosure.

FIG. 11 is a schematic structural diagram of a second body of an electronic device after the second body rotates with respect to a first body, consistent with embodiments of the present disclosure.

FIG. 12 is a schematic structural diagram of another electronic device when a second body rotates to a first angle with respect to a first body, consistent with embodiments of the present disclosure.

FIG. 13 is a schematic structural diagram of another electronic device when a second body rotates to a second angle with respect to a first body, consistent with embodiments of the present disclosure.

FIG. 14 is a schematic structural diagram of another electronic device when a second body rotates to a third angle with respect to a first body, consistent with embodiments of the present disclosure.

FIG. 15 is a schematic structural diagram of another electronic device when a second body rotates to a fifth angle with respect to a first body, consistent with embodiments of the present disclosure.

FIG. 16 is a schematic structural diagram of another electronic device after a second body rotates with respect to a first body, consistent with embodiments of the present disclosure.

### NUMERAL REFERENCES

10—Connection device; 11—First rotation assembly; 111—First connection member; 1111—Screw hole; 112—First shaft; 1121—First guide slope; 1122—Second guide slope; 1123—First limit recess; 1124—Second limit recess; 1125—Third guide slope; 1126—Fourth guide slope; 1127—Third limit protrusion; 1128—Fourth limit protrusion; 113—Second shaft; 1131—First guide groove; 1132—Second guide groove; 12—Second rotation assembly; 121—First member; 1211—First limit protrusion; 1212—Third limit recess; 122—Second member; 1221—Second limit protrusion; 1222—Fourth limit recess; 123—Torsion member; 1231—Third connection member; 1232—Plate; 13—Support assembly; 131—Second connection member; 132—First support member; 1321—First sub-support member; 133—Second support member; 1322—Second sub-support member; 14—Slide rail assembly; 141—First boss; 142—Second boss; 151—First limit member; 152—Second limit member; 16—Damping structure; 20—Electronic device; 21—First body; 211—Input device; 22—Second body; 221—First display device; 222—Second display device.

### DETAILED DESCRIPTION OF THE EMBODIMENTS

Embodiments of the present disclosure will be described below in connection with the drawings. Obviously, the described embodiments are only part of the embodiments of the present disclosure, but not all of the embodiments. Based on the embodiments in the present disclosure, all other embodiments obtained by those skilled in the art without making creative work are within the scope of the present disclosure.

The present disclosure provides these embodiments for the purpose of illustrating the present disclosure, and to describe the scope of the present disclosure. It should be noted that unless otherwise specified, the relative arrangement of the assemblies and steps, the composition of the materials, the numerical expressions and the numerical values described in these embodiments should be interpreted as merely exemplary, and not as limitations.

It should be noted that in the description of the present disclosure, unless otherwise specified, the meaning of “multiple” is larger than or equal to two. The orientation or position relationship indicated by the terms “upper,” “lower,” “left,” “right,” “inner,” “outer,” etc. is only for the convenience of describing the present disclosure and simplifying the description, and does not indicate or imply that the device or element referred to must have a specific orientation, be constructed and operated in a specific orientation, and therefore cannot be understood as a limitation on the present disclosure. When the absolute position of the described object changes, the relative position relationship may also change accordingly.

In addition, the words “first,” “second” and similar words used in the present disclosure do not indicate any order, quantity or importance, but are only used to distinguish different members. “Vertical” is not strictly perpendicular, but within the allowable error range. “Parallel” is not strictly parallel, but within the allowable error range. “Include” or “comprises” and similar words mean that the elements before the word include the elements listed after the word, and do not exclude the possibility of including other elements.

It should also be noted that in the description of this disclosure, unless otherwise clearly specified and limited, the terms “install” and “connect” should be understood in a broad sense. For example, it can be a fixed connection, a detachable connection, or an integral connection; it can be directly connected or indirectly connected through an intermediate medium. For those skilled in the art, the specific meanings of the above terms in this disclosure can be understood according to the specific circumstances. When a specific device is described as being located between a first device and a second device, there may or may not be an intermediate device between the specific device and the first device or the second device.

All terms used in this disclosure have the same meaning as understood by those skilled in the art to which this disclosure belongs, unless otherwise specifically defined. It should also be understood that terms defined in general dictionaries, such as general dictionaries, should be interpreted as having a meaning consistent with their meaning in the context of the relevant technology, and should not be interpreted in an idealized or extremely formal sense, unless explicitly defined here.

Technologies, methods, and equipment known to those skilled in the art may not be discussed in detail, but where appropriate, the technologies, methods, and equipment should be considered part of the specification.

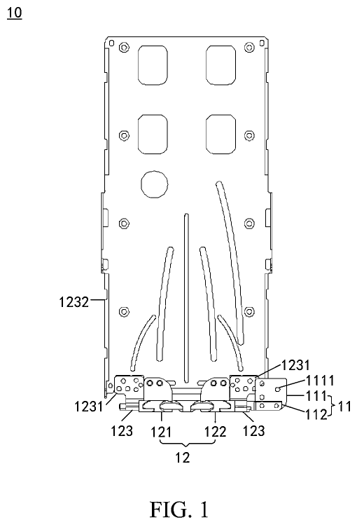

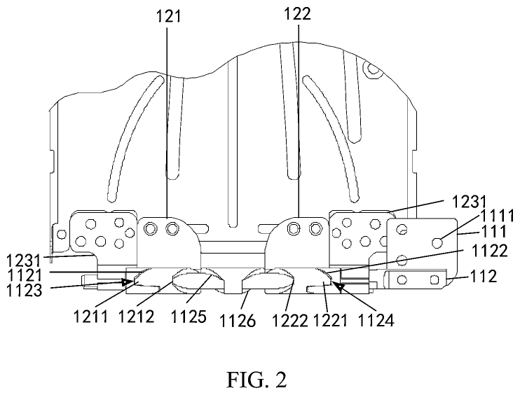

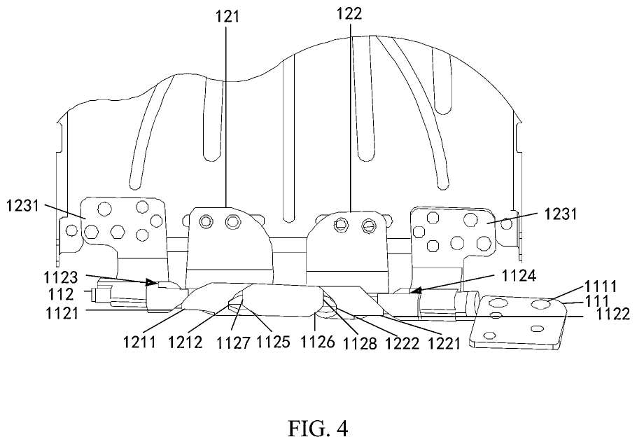

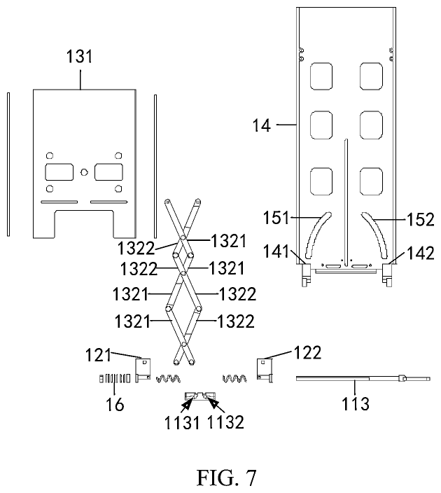

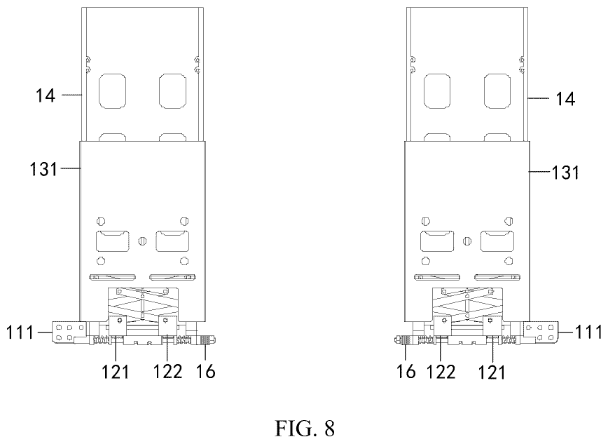

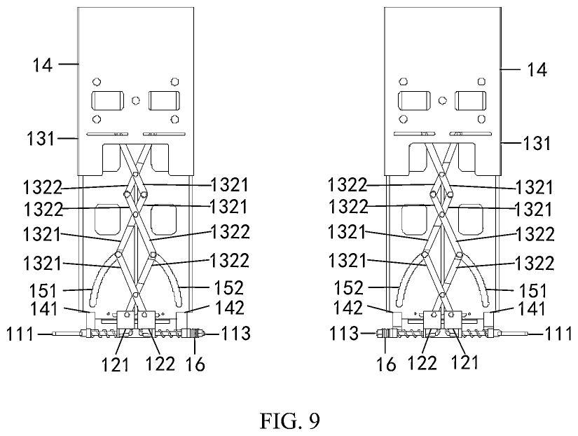

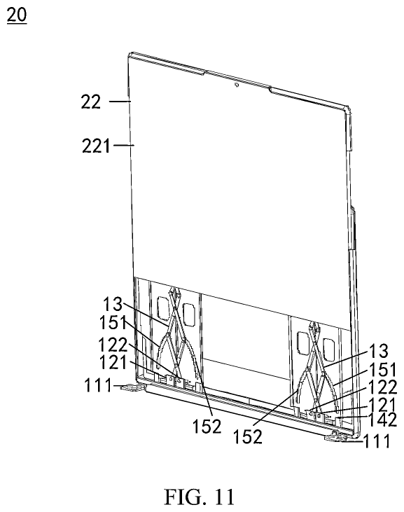

One embodiment of the present disclosure provides a connection device 10. As shown in FIG. 1 to FIG. 16, the connection device 10 includes: a first rotation assembly 11, a second rotation assembly 12, and a support assembly 13. The first rotation assembly 11 is provided with a first connection member 111. The second rotation assembly 12 is rotatably connected to the first rotation assembly 11, and the second rotation assembly 12 is able to rotate relative to the first rotation assembly 11 to cause a relative displacement of the first member 121 and the second member 122 on the second rotation assembly 12. The support assembly 13 is connected to the first member 121 and the second member 122, and the support assembly 13 is provided with a second connection member 131, such that the second connection member 131 moves relative to the first connection member 111 when the second rotation assembly 12 rotates relative to the first rotation assembly 11.

The first rotation assembly 11 may include the first connection member 111. The first connection member 111 may be connected to a first body 21 (e.g., a system terminal having an input device 211 on a laptop computer) of an electronic device 20 (e.g., the laptop computer) to achieve a connection between the first rotation assembly 11 and the first body 21. For example, in one embodiment, as shown in FIG. 1 to FIG. 4, the first connection member 111 is a metal sheet, and a plurality of screw holes 1111 is provided at the metal sheet, and screws may pass through the plurality of screw holes 111 and be connected to the first body 21.

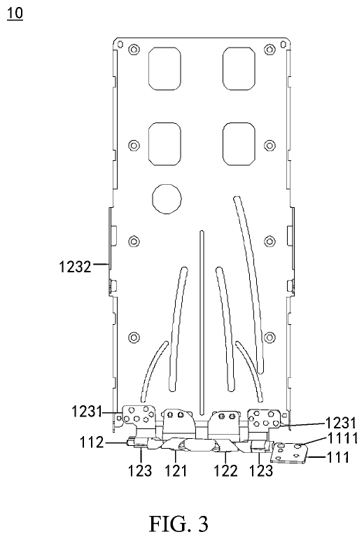

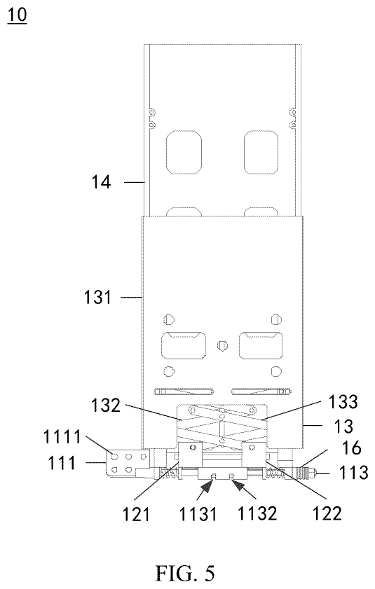

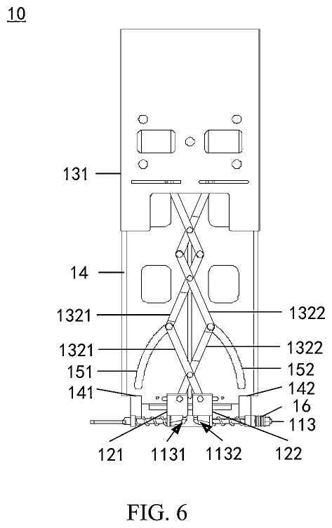

The second rotation assembly 12 may be rotatably connected to the first rotation assembly 11, and the second rotation assembly 12 may rotate relative to the first rotation assembly 11 such that the first member 121 and the second member 122 on the second rotation assembly 12 are relatively displaced. That is, during the rotation of the second rotation assembly 12 relative to the first rotation assembly 11, the first member 121 and the second member 122 provided at the second rotation assembly 12 may move respectively such that the first member 121 and the second member 122 are relatively displaced, and the relative displacement here may be a displacement close to each other or a displacement away from each other. For example, in an initial state, as shown in FIG. 1 (or in FIG. 5), the first member 121 and the second member 122 are spaced apart from each other. After the second rotation assembly 12 rotates forwardly relative to the first rotation assembly 11, as shown in FIG. 3 (or in FIG. 6), the first member 121 and the second member 122 become closer to each other, and the relative displacement in this process is a displacement of moving toward each other. The second rotation assembly 12 may rotate reversely relative to the first rotation assembly 11 to restore to the initial state, and the relative displacement in this process may be a displacement of moving away from each other.

The support assembly 13 may be connected to the first member 121 and the second member 122, and the support assembly 13 may be provided with the second connection member 131, such that the second connection member 131 moves relative to the first connection member 111 when the second rotation assembly 12 rotates relative to the first rotation assembly 11. That is, two places on the support assembly 13 may be connected to the first member 121 and the second member 122 respectively. Since the first member 121 and the second member 122 on the second rotation assembly 12 are able to move when the second rotation assembly 12 rotates relative to the first rotation assembly 11 such that the first member 121 and the second member 122 are relatively displaced, two places on the support assembly 13 may be connected to the first member 121 and the second member 122 respectively, and the two places may be able to change their positions with the movement of the first member 121 and the second member 122, thereby making the second connection member 131 on the support assembly 13 move relative to the first connection member 111 and produce a change in position. Therefore, the position of the first display device 221 of the second body 22 connected to the second connection member 131 may change.

In one embodiment, the electronic device 20 may include: a first body 21, a second body 22, and the connection device 10. The first body 21 may be a system terminal of a laptop computer including an input device 211, and the second body 22 may be a display terminal of a laptop computer including a first display device 221. As shown in FIG. 1 to FIG. 7, the connection device 10 includes: a first rotation assembly 11, a second rotation assembly 12, and a support assembly 13. The first rotation assembly 11 is provided with a first connection member 111 capable of connection to the first body 21; the second rotation assembly 12 is rotatably connected to the first rotation assembly 11. The second rotation assembly 12 may be rotatably connected to the first rotation assembly 11. The rotation assembly 12 may rotate relative to the first rotation assembly 11 such that the first member 121 and the second member 122 on the second rotation assembly 12 are close to or away from each other in the axial direction parallel to the first rotation assembly 11. Two places on the support assembly 13 may be respectively connected to the first member 121 and the second member 122, and the support assembly 13 may be provided with a second connection member 131 that may be connected to the first display device 221 on the second body 22. Therefore, when the second rotation assembly 12 rotates relative to the first rotation assembly 11, the second connection member 131 may move toward the axial position away from the first rotation assembly 11. In this way, during the positive rotation of the second rotation assembly 12 relative to the first rotation assembly 11, the second body 22 may rotate relative to the first body 21 such that the angle between the second body 22 and the first body 21 increases, and at the same time the first member 121 and the second member 122 may move relatively away from each other, and drive the support assembly 13 connected to the first member 121 and the second member 122 to move with the first display device 221 in a direction away from the first body 21. That is, the first display device 221 may be lifted relative to the first body 21. During the reverse rotation of the second rotation assembly 12 relative to the first rotation assembly 11, the second body 22 may rotate relative to the first body 21 such that the angle between the second body 22 and the first body 21 decreases. And at the same time the first member 121 and the second member 122 may move relatively close to each other, and drive the support assembly 13 connected to the first member 121 and the second member 122 to move with the first display device 221 in a direction close to the first body 21, that is, the first display device 221 may descend relative to the first body 21. For the convenience of description, the following description will take one embodiment where the connection device 10 is arranged on a laptop computer, the first connection member 111 is connected to a system terminal having an input device 211 on the laptop computer, and the second connection member 131 is connected to a first display device 221, as an example.

In the present disclosure, the connection device 10 may include: the first rotation assembly 11, the second rotation assembly 12, and the support assembly 13. The first connection member 111 on the first rotation assembly 11 may be connected to the system terminal of the laptop computer. The second rotation assembly 12 may be rotatably connected to the first rotation assembly 11, such that the first display device 221 of the display terminal connected to the second connection member 131 on the support assembly 13 connected to the second rotation assembly 12 is able to rotate relative to the first rotation assembly 11 synchronously with the second rotation assembly 12, therefore realizing the rotation of the first display device 221 relative to the system terminal. Further, during the rotation of the first display device 221 relative to the system terminal, the first member 121 and the second member 122 on the second rotation assembly 12 may be relatively displaced, and the support assembly 13 may convert the relative displacement into the lifting displacement of the first display device 221 relative to the system terminal. Therefore, when the user uses the laptop computer, the position of the first display device 221 may be lifted, such that the user does not need to lower his head to view the content displayed on the first display device 221, thereby reducing the probability of cervical fatigue of the user and reducing the probability of affecting the user's physical health to provide a better user experience. Further, because of the lifted position of the first display device 221, the contact area between the electronic device 20 and the air may be increased, thereby improving the heat dissipation efficiency of the electronic device 20.

Structures of two exemplary connection devices 10 will be used as examples to illustrate the present disclosure, which does not limit the scope of the present disclosure. In some other embodiments, the connection device 10 may also have other appropriate structures.

In one embodiment shown in FIG. 1 to FIG. 4, the first rotation assembly 11 includes a first shaft 112, and a first guide slope 1121 and a second guide slope 1122 distributed along the axial direction of the first shaft 112 are arranged at the circumference of the first shaft 112. The first guide slope 1121 and the second guide slope 1122 are both inclined with respect to the axial direction. The first member 121 and the second member 122 are rotatably mounted at the first shaft 112 respectively. The first member 121 abuts against the first guide slope 1121 and is able to be displaced along the first guide slope 1121, and the second member 122 abuts against the second guide slope 1122 and is able to be displaced along the second guide slope 1122.

The first guide slope 1121 and the second guide slope 1122 distributed along the axial direction of the first shaft 112 may be disposed at the circumference of the first shaft 112. The first guide slope 1121 and the second guide slope 1122 may both be inclined with respect to the axial direction. For example, the first shaft 112 may be a cylindrical structure, and the surface in the circumferential direction of the first shaft 112 may be respectively provided with the first guide slope 1121 and the second guide slope 1122 along the length direction of the first shaft 112. The first guide slope 1121 and the second guide slope 1122 may be both inclined relative to the axial direction (or the length direction) of the first shaft 112. The first guide slope 1121 or the second guide slope 1122 may be an inclined surface at one end of a protrusion integrally formed on the first shaft 112, or may be an inclined surface provided by a structural member fixedly or detachably connected to the first shaft 112.

The first member 121 and the second member 122 may be rotatably mounted at the first shaft 112. The first member 121 may abut against the first guide slope 1121 and may be displaced along the first guide slope 1121. The second member 122 may abut against the second guide slope 1122 and may be displaced along the second guide slope 1122. Therefore, the first member 121 may be displaced along the first guide slope 1121 in the axial direction of the first shaft 112, and the second member 122 may be displaced along the second guide slope 1122 in the axial direction of the first shaft 112. The direction in which the two parts are displaced may be related to the inclination direction of the two guide slopes respectively, and the unit displacement of the two parts may be related to the inclination of the two guide slopes respectively, which may be set here according to specific needs. In one embodiment, the support assembly 13 may convert the displacement of the first member 121 or the second member 122 along the first shaft 112 in the axial direction parallel to the first shaft 112 into a displacement in the parallel axis direction, the inclined axis direction or the vertical axis direction, such that the first display device 221 connected to the second connection member 131 of the support assembly 13 is able to move relative to the system terminal. For example, the support assembly 13 may convert the displacement of the first member 121 or the second member 122 along the first shaft 112 in the axial direction parallel to the first shaft 112 into a displacement in the parallel axis direction and/or the inclined axis direction, such that the first display device 221 is able to move parallel and/or tilt relative to the system terminal. Therefore, when the user is using the laptop computer at a window position and sunlight directly shines on the first display device 221 causing the light received by the user's eyes to be too strong and dazzling, the user may move the first display device 221 parallel and/or tilt relative to the system terminal such that the sunlight no longer directly shines on the first display device 221.

In one embodiment, as shown in FIG. 1 to FIG. 4, the first shaft 112 includes two protrusions, and two surfaces opposite to each other on the two protrusions are respectively inclined to form the first guide slope 1121 and the second guide slope 1122. The inclination directions of the first guide slope 1121 and the second guide slope 1122 are opposite. The first member 121 and the second member 122 may be respectively sleeved on the first shaft 112 and located between the first guide slope 1121 and the second guide slope 1122. The first member 121 and the second member 122 may be respectively connected to the corresponding ends of a first connection rod (not shown in the figure, refer to the first support member 131 below) and a second connection rod (not shown in the figure, refer to the second support member 132 below) hinged to each other. Other ends of the first connection rod and the second connection rod may be slidably connected to the second connection member 131 (such as a connection plate), where the sliding direction is consistent with the axial direction of the first shaft 112. When the first display device 221 rotates relative to the system terminal such that the angle between the first display device 221 and the system terminal gradually increases, the first member 121 and the second member 122 approach each other, such that the first connection rod and the second connection rod rotate relative to each other and the angle between the first connection rod and the second connection rod becomes smaller, thereby making the length of the cross structure composed of the first connection rod and the second connection rod in the direction perpendicular to the first shaft 112 increase. Therefore, the first display device 221 connected to the second connection member 131 may be lifted in the direction away from the system terminal.

The first rotation assembly 11 may include the first shaft 112, and the first guide slope 1121 and the second guide slope 1122 may be disposed on the first shaft 112. The first member 121 and the second member 122 of the second rotation assembly 12 may be respectively mounted at the first shaft 112 and may be able to move along the first guide slope 1121 and the second guide slope 1122 respectively, to generate a displacement parallel to the axial direction of the first shaft 112. The support assembly 13 may convert the displacement to drive the first display device 221 connected to the second connection member 131 on the support assembly 13 to move relative to the system terminal. Therefore, the position change (such as lifting) of the first display device 221 may be conveniently achieved. Further, since the first member 121 and the second member 122 move along the first guide slope 1121 and the second guide slope 1122 respectively during the movement process, the movement process of the first member 121 and the second member 122 may be smoother and more stable.

In some embodiments, as shown in FIG. 1 to FIG. 4, the first shaft 112 is provided with a first limit recess 1123 connected to the first guide slope 1121, and the first guide slope 1121 and the first limit recess 1123 may be distributed along the circumference of the first shaft 112. The first member 121 may be provided with a first limit protrusion 1211 corresponding to the first limit recess 1123. And/or, the first shaft 112 may be provided with a second limit recess 1124 connected to the second guide slope 1122, and the second guide slope 1122 and the second limit recess 1124 may be distributed along the circumference of the first shaft 112. The second member 122 may be provided with a second limit protrusion 1221 corresponding to the second limit recess 1124.

The first shaft 112 may be provided with the first limit recess 1123 connected to the first guide slope 1121, and the first guide slope 1121 and the first limit recess 1123 may be distributed along the circumference of the first shaft 112. That is, the first guide slope 1121 and the first limit recess 1123 may be distributed along a circle of the circumferential surface of the first shaft 112. For example, a first protrusion may be raised on the first shaft 112, and a circle surface of the first protrusion corresponding to one end of the first shaft 112 may be provided with the first limit recess 1123 and the first guide slope 1121 connected thereto, such that the first limit protrusion 1211 of the first member 121 sleeved on the first shaft 112 may be located in the first limit recess 1123. Therefore, when the first member 121 rotates forwardly relative to the first shaft 112, the first limit protrusion 1211 is separated from the first limit recess 1123 and the first member 121 rotates forwardly along the first guide slope 1121, such that the angle between the system terminal connected to the first connection member 111 and the first display device 221 connected to the second connection member 131 increases. When the first member 121 rotates reversely relative to the first shaft 112, the first member 121 may rotate reversely along the first guide slope 1121, and the first limit protrusion 1211 may enter the first limit recess 1123 to return to the original position to realize the rotation of the first display device 221 and the system terminal back to the position before the forward rotation.

The arrangement of the second limit recess 1124 and the second limit protrusion 1221 may refer to the setting between the first limit recess 1123 and the first limit protrusion 1211, which will not be repeated here. It should be noted that the setting of the second limit recess 1124 and the second guide slope 1122 may be consistent with the setting of the first limit recess 1123 and the first guide slope 1121, or may be symmetrical with the setting of the first limit recess 1123 and the first guide slope 1121 as shown in FIG. 1 to FIG. 4; or may be different from the setting of the first limit recess 1123 and the first guide slope 1121.

In this embodiment, the first limit recess 1123 connected to the first guide slope 1121 may be provided at the first shaft 112, and the first member 121 sleeved on the first shaft 112 may be provided with the first limit protrusion 1211 matching the first limit recess 1123, such that the initial position of the first member 121 may be limited. Similarly, the second limit recess 1124 connected to the second guide slope 1122 may be provided at the first shaft 112, and the second member 122 sleeved on the first shaft 112 may be provided with the second limit protrusion 1221 matching the second limit recess 1124, such that the initial position of the second member 122 may be limited.

In some embodiments, as shown in FIG. 1 to FIG. 4, a third guide slope 1125 and a fourth guide slope 1126 distributed along the axial direction of the first shaft 112 are also provided at the circumference of the first shaft 112, and the third guide slope 1125 and the fourth guide slope 1126 are located between the first guide slope 1121 and the second guide slope 1122. The third guide slope 1125 is inclined in the opposite direction to the first guide slope 1121, and the fourth guide slope 1126 is inclined in the opposite direction to the second guide slope 1122. One end of the first member 121 away from the first guide slope 1121 may abut against the third guide slope 1125, and one end of the second member 122 away from the second guide slope 1122 may abut against the fourth guide slope 1126. Therefore, the two sides of the first member 121 may abut against the first guide slope 1121 and the third guide slope 1125 in sequence, such that the rotation process of the first member 121 is smoother and more stable. The two sides of the second member 122 may abut against the second guide slope 1122 and the fourth guide slope 1126 in sequence, such that the rotation process of the second member 122 is smoother and more stable.

Further, as shown in FIG. 1 to FIG. 4, a third limit protrusion 1127 connected to the third guide slope 1125 may also be provided at the first shaft 112. The third guide slope 1125 and the third limit protrusion 1127 may be distributed along the circumference of the first shaft 112. The third limit protrusion 1127 and the first limit recess 1123 may be offset from each other, and the first member 121 may be provided with a third limit recess 1212 corresponding to the third limit protrusion 1127. And/or, a fourth limit protrusion 1128 connected to the fourth guide slope 1126 may also be provided at the first shaft 112. The fourth guide slope 1126 and the fourth limit protrusion 1128 may be distributed along the circumference of the first shaft 112. The fourth limit protrusion 1128 and the second limit recess 1124 may be offset from each other, and the second member 122 may be provided with a fourth limit recess 1222 corresponding to the fourth limit protrusion 1128. Thus, before the first member 121 rotates relative to the first shaft 112, the first limit protrusion 1211 may be correspondingly located in the first limit recess 1123. When the first member 121 rotates relative to the first shaft 112, the first limit protrusion 1211 may be separated from the first limit recess 1123, and then the first member 121 may rotate against the first guide slope 1121 and the third guide slope 1125 in sequence, and finally the third limit recess 1212 may be correspondingly located in the third limit protrusion 1127, to limit the first member 121 after rotation. Similarly, before the second member 122 rotates relative to the first shaft 112, the second limit protrusion 1221 may be correspondingly located in the second limit recess 1124. When the second member 122 rotates relative to the first shaft 112, the second limit protrusion 1221 may be separated from the second limit recess 1124, and then the second member 122 may rotate against the second guide slope 1122 and the fourth guide slope 1126 in sequence, and finally the fourth limit recess 1222 may be correspondingly located in the fourth limit protrusion 1128, to limit the rotation of the second member 122. Therefore, the movement distance of the first display device 221 may be limited by the misalignment distance between the third limit protrusion 1127 and the first limit recess 1123, and the misalignment distance between the fourth limit protrusion 1128 and the second limit recess 1124 may be consistent with the misalignment distance between the third limit protrusion 1127 and the first limit recess 1123.

In some embodiments, as shown in FIG. 1 to FIG. 4, the second rotation assembly 12 further includes: a torsion member 123, which is rotatably sleeved on the first shaft 112. The friction between the torsion member 123 and the first shaft 112 may be larger than the friction between any one of the first member 121 and the second member 122 and the first shaft 112, and the torsion member 123 may be provided with a third connection member 1231.

The torsion member 123 may be rotatably mounted at the first shaft 112, and the friction force between the torsion member 123 and the first shaft 112 may be larger than the friction force between any one of the first member 121 and the second member 122 and the first shaft 112. That is, during the rotation of the second rotation assembly 12 relative to the first rotation assembly 11, the first member 121, the second member 122 and the torsion member 123 may rotate relative to the first shaft 112 respectively, and the friction force between the torsion member 123 and the first shaft 112 may be larger than the friction force between any one of the first member 121 and the second member 122 and the first shaft 112, such that the first rotation assembly 11 and the second rotation assembly 12 are stabilized in the rotated position. The torsion member 123 may be a non-smooth surface corresponding to the surface on which the first shaft 112 is sleeved. In comparison with the surface on which the first member 121 and the second member 122 are sleeved corresponding to the first shaft 112 is a smooth surface, the friction between the torsion member 123 and the first shaft 112 may be larger than the friction between any one of the first member 121 and the second member 122 and the first shaft 112. The torsion member 123 may also be a C-shaped structure, which is sleeved on the first shaft 112 in an interlocking manner, and the internal space of the C-shaped structure may be slightly smaller than the radial dimension of the first shaft 112. In comparison with the inner diameter of the first shaft 112 where the first member 121 and the second member 122 are respectively sleeved equal to the radial dimension of the first shaft 112, the friction between the torsion member 123 and the first shaft 112 may be larger than the friction between any one of the first member 121 and the second member 122 and the first shaft 112. In other embodiments, other settings to make the friction between the torsion member 123 and the first shaft 112 greater than the friction between any one of the first member 121 and the second member 122 and the first shaft 112 may be adopted.

The torsion member 123 may be provided with the third connection member 1231. The third connection member 1231 may be connected to the housing of the display terminal or may be connected to the first display device 221. It should be noted that when the third connection member 1231 is connected to the first display device 221, the first display device 221 may be movably connected to the third connection member 1231 so as not to affect the movement of the first display device 221 relatives to the system terminal. For example, in one embodiment shown in FIG. 1 and FIG. 3, the third connection member 1231 is connected to a plate 1232, and the plate 1232 may be connected to the housing of the display terminal. The plate 1232 may be connected to multiple connection positions of the housing of the display terminal to make the connection structure of the laptop computer more secure.

In some embodiments shown in FIG. 1 to FIG. 4, the connection device 10 may include the first rotation assembly 11, the second rotation assembly 12 and the support assembly 13.

The first rotation assembly 11 may include a first shaft 112 and a first connection member 111. A first guide slope 1121, a third guide slope 1125, a fourth guide slope 1126 and a second guide slope 1122 may be arranged at the circumference of the first shaft 112 and distributed along the axial direction of the first shaft 112. The first guide slope 1121, the third guide slope 1125, the fourth guide slope 1126 and the second guide slope 1122 may be all inclined with respect to the axial direction of the first shaft 112. The first guide slope 1121 and the third guide slope 1125 may be inclined in opposite directions, and the fourth guide slope 1126 and the second guide slope 1122 may be inclined in opposite directions. The first shaft 112 may also be provided with a first limit recess 1123 connected to the first guide slope 1121, and the first guide slope 1121 and the first limit recess 1123 may be distributed along the circumference of the first shaft 112. The first shaft 112 may also be provided with a third limit protrusion 1127 connected to the third guide slope 1125, and the third guide slope 1125 and the third limit protrusion 1127 may be distributed along the circumference of the first shaft 112. The third limit protrusion 1127 and the first limit concave 1123 may be staggered with each other. The first shaft 112 may be also provided with a second limit recess 1124 connected to the second guide slope 1122, and the second guide slope 1122 and the second limit recess 1124 may be distributed along the circumference of the first shaft 112. The first shaft 112 may be also provided with a fourth limit protrusion 1128 connected to the fourth guide slope 1126, and the fourth guide slope 1126 and the fourth limit protrusion 1128 may be distributed along the circumference of the first shaft 112. The fourth limit protrusion 1128 and the second limit recess 1124 may be staggered with each other. The two ends of the first shaft 112 may be respectively connected with the first connection member 111, and the first connection member 111 may be used to connect with the system terminal of the notebook computer.

The second rotation assembly 12 may include: a first member 121, a second member 122, and a torsion member 123. The first member 121 and the second member 122 may be rotatably sleeved on the first shaft 112. The two ends of the first member 121 may correspond to the first guide slope 1121 and the third guide slope 1125, respectively. The first member 121 may be provided with a first limit protrusion 1211 corresponding to the first limit recess 1123 and a third limit recess 1212 corresponding to the third limit protrusion 1127. The two ends of the second member 122 may correspond to the second guide slope 1122 and the fourth guide slope 1126, respectively. The second member 122 may be provided with a second limit protrusion 1221 corresponding to the second limit recess 1124 and a fourth limit recess 1222 corresponding to the fourth limit protrusion 1128. The torsion member 123 may be rotatably sleeved on the first shaft 112, and the friction force between the torsion member 123 and the first shaft 112 may be greater than the friction force between any one of the first member 121 and the second member 122 and the first shaft 112, and the torsion member 123 may be provided with a third connection member 1231 connected to the display terminal of the notebook computer.

The support assembly 13 may be connected to the first member 121 and the second member 122 respectively, and the support assembly 13 may be provided with a second connection member 131 connected to the first display device 221 of the display terminal, such that when the second rotation assembly 12 rotates relative to the first rotation assembly 11, the second connection member 131 moves relative to the first connection member 111.

In the process that the second rotation assembly 12 rotates relative to the first rotation assembly 11 to increase the angle between the first display device 221 and the system terminal, the first display device 221 may be lifted relative to the system terminal.

The present disclosure also provides another connection device.

In one embodiment, as shown in FIG. 5 to FIG. 11, the first rotation assembly 11 includes: a second shaft 113, and the circumference of the second shaft 113 is provided with a first guide groove 1131 and a second guide groove 1132 distributed along the axial direction of the second shaft 113. The first member 121 and the second member 122 are rotatably sleeved on the second shaft 113. The first member 121 is provided with a third guide groove, and the second member 122 is provided with a fourth guide groove. One of the third guide groove and the first guide groove 1131 extends spirally along the axial direction of the second shaft 113, and one of the fourth guide groove and the second guide groove 1132 extends spirally along the axial direction of the second shaft 11. The second rotation assembly 12 also includes: a first ball and a second ball. The first ball abuts against the first guide groove 1131 and the third guide groove, and the second ball abuts against the second guide groove 1132 and the fourth guide groove. Therefore, the first member 121 and the second shaft 113 may be able to slide along the length direction of the second shaft 113 under the cooperation of the first guide groove 1131, the third guide groove and the first ball, and the second member 122 and the second shaft 113 may be able to slide along the length direction of the second shaft 113 under the cooperation of the second guide groove 1132, the fourth guide groove and the second ball, thereby realizing the relative movement of the first member 121 and the second member 122.

In one embodiment, the second shaft 113 may be a round rod, a rectangular rod, a triangular rod or the like. Among the first guide groove 1131 and the third guide groove mentioned above, one of the guide grooves may extend spirally along the axial direction of the second shaft 113, and the other guide groove may be a hemispherical groove, such that the first ball is able to be fixedly connected in the hemispherical groove, or is able to be integrally formed in the hemispherical groove. Similarly, among the second guide groove 1132 and the fourth guide groove, one of the guide grooves may extend spirally along the axial direction of the second shaft 113, and the other guide groove may be a hemispherical groove, such that the second ball is able to be fixedly connected in the hemispherical groove or be integrally formed in the hemispherical groove.

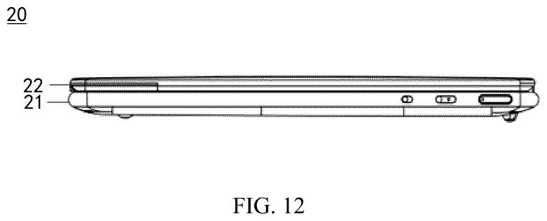

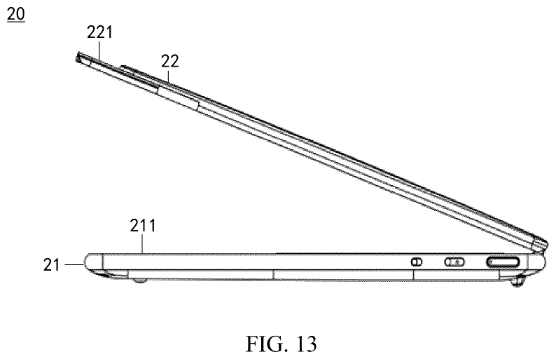

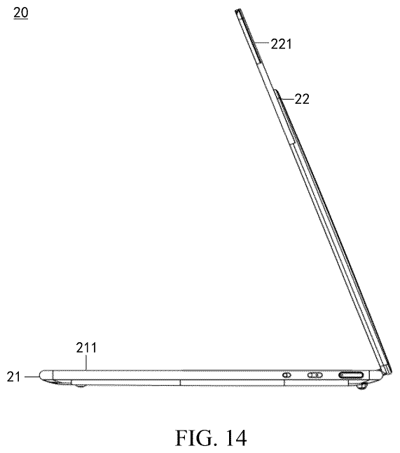

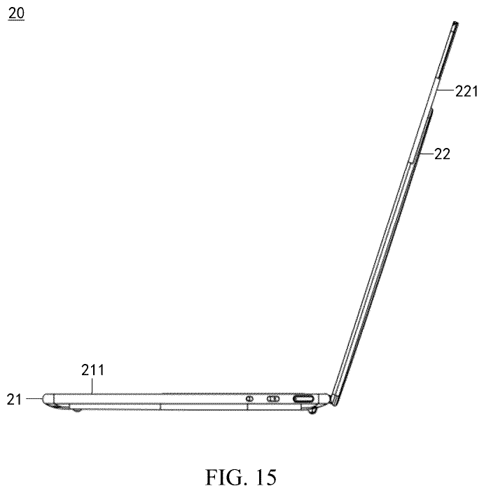

When the first ball and the second ball are located at the ends of the corresponding spiral guide grooves, they may be able to rotate respectively relative to the corresponding spiral guide grooves without displacement in the direction parallel to the axis of the second shaft 113. At the same time, when the length of the spiral guide grooves is longer, the height to which the first display device 221 rises may be larger. Therefore, the height to which the first display device 221 rises may be controlled by controlling the length of the spiral guide grooves. For example, FIG. 12 is a schematic diagram of the structure when the second body 22 rotates to a first angle relative to the first body 21, where the first angle may be understood as 0 degrees; FIG. 13 is a schematic diagram of the structure when the second body 22 rotates to a second angle relative to the first body 21, where the second angle may be understood as 20 degrees; FIG. 14 is a schematic diagram of the structure when the second body 22 rotates to a third angle relative to the first body 21, where the third angle can be understood as 70 degrees; and, FIG. 15 is a schematic diagram of the structure when the second body 22 rotates to a fourth angle relative to the first body 21, where the fourth angle can be understood as 110 degrees. In the process of the second body 22 rotating from 0 degrees to 70 degrees relative to the first body 21, the first display device 221 on the second body 22 rises, and in the process of rotating from 70 degrees to 180 degrees, the first display device 221 does not continue to rise relative to the second body 22. In the process of rotating from 180 degrees to 70 degrees, the first display device 221 may not rise or descend relative to the second body 22, and in the process from 70 degrees to 0 degrees, the first display device 221 may descend and return to its original position at the 0 degree position.

In some embodiments, as shown in FIG. 5 and FIG. 6, the first member 121 and the second member 122 of the second rotation assembly 12 may be able to move relative to each other in a first direction and generate a first displacement. The first direction may satisfy the parallel condition with the axis direction of the first rotation assembly 11. The support assembly 13 may be able to move relative to the axis of the first rotation assembly 11 in a second direction and generate a second displacement. The second direction may satisfy the perpendicular condition with the axis direction of the first rotation assembly 11. The support assembly 13 may convert the first displacement in the first direction into the second displacement in the second direction, and the second displacement may not be less than the first displacement. In other words, the support assembly 13 may convert the displacement in the direction parallel to the axis direction of the first rotation assembly 11 into the displacement in the direction perpendicular to the axis direction of the first rotation assembly 11, such that the first display device 221 may be lifted, and the lifting distance of the first display device 221 may be larger than or equal to the displacement of the first member 121 and the second member 122 in the direction of the axis direction of the first rotation assembly 11.

In some embodiments, as shown in FIG. 5 to FIG. 11, the support assembly 13 includes: a first support member 132, and a second support member 133. The first support member 132 includes a plurality of first sub-support members 1321 hinged in sequence, and the second support member 133 includes a plurality of second sub-support members 1322 hinged in sequence. The plurality of first sub-support members 1321 and the plurality of second sub-support members 1322 may be hinged correspondingly such that the first support member 132 and the second support member 133 form a network and are able to be extended or shortened after relative rotation. The corresponding ends of the first support member 132 and the second support member 133 may be respectively connected to the first member 121 and the second member 122, and the corresponding other ends of the first support member 132 and the second support member 133 may both be connected to the second connection member 131.

The first support member 132 may include the plurality of first sub-support members 1321 hinged in sequence, such that two adjacent first sub-support members 1321 are able to rotate relative to each other. The second support member 133 may include the plurality of second sub-support members 1322 hinged in sequence, such that two adjacent second sub-support members 1322 are able to rotate relative to each other. The plurality of first sub-support members 1321 and the plurality of second sub-support members 1322 may be hinged correspondingly such that the first support member 132 and the second support member 133 form a network and are able to be extended or shortened after relative rotation. For example, the middle position of one corresponding first sub-support member 1321 and the middle position of one second sub-support member 1322 may be hinged such that the corresponding first sub-support member 1321 and the second sub-support member 1322 form an X shape, and the corresponding first sub-support members 1321 and the second sub-support member 1322 are able to rotate relative to each other.

In one embodiment, the first support member 132 and the second support member 133 may form a mesh and may be extended or shortened after relative rotation. The corresponding ends of the first support member 132 and the second support member 133 may be respectively connected to the first member 121 and the second member 122, and the corresponding other ends of the first support member 132 and the second support member 133 may be connected to the second connection member 131. Therefore, when the first member 121 and the second member 122 are relatively displaced, the first support member 132 and the second support member 133 may be extended or shortened. In this way, the first display device 221 connected by the other ends of the first support member 132 and the second support member 133 through the second connection member 131 may approach or move away from the first member 121 and the second member 122, thereby realizing the rising and descending of the first display device 221.

In some embodiments, as shown in FIG. 5 to FIG. 9, the connection device 10 also includes: a slide rail assembly 14. The slide rail assembly 14 is slidably connected to the second connection member 131, and the slide rail assembly 14 is provided with a first boss 141 and a second boss 142 near the first rotation assembly 11. One first sub-support member 1321 connected to the first member 121 may be connected to a first limit member 151 at one end away from the first member 121, and one second sub-support member 1322 connected to the second member 122 may be connected to a second limit member 152 at one end away from the second member 122. After the support assembly 13 is shortened, the first limit member 151 and the second limit member 152 may respectively abut against the first boss 141 and the second boss 142. The slide rail assembly 14 may be slidably connected to the second connection member 131, such that the second connection member 131 is able to move more smoothly with the first display device 221. After the support assembly 13 is shortened, the first limit member 151 and the second limit member 152 may respectively abut against the first boss 141 and the second boss 142, such that the support assembly 13 is stabilized in the shortened position after being shortened.

In some embodiments, as shown in FIG. 5 to FIG. 11, the connection device 10 includes the first rotation assembly 11, the second rotation assembly 12, the support assembly 13, and the slide rail assembly 14. 5 to 11

The first rotation assembly 11 may include: a second shaft 113 and a first connection member 111. The circumference of the second shaft 113 may be provided with a first guide groove 1131 and a second guide groove 1132 distributed along the axial direction of the second shaft 113. The first guide groove 1131 and the second guide groove 1132 may respectively extend in a spiral shape along the axial direction of the second shaft 113. The two ends of the second shaft 113 may be respectively connected with a first connection member 111, and the first connection member 111 may be used to connect the first body 21 of the electronic device 20. The second rotation assembly 12 may include: a first member 121, a second member 122, a first ball, a second ball, a first spring, a second spring and two damping structures 16. The first member 121 and the second member 122 may be rotatably sleeved on the second shaft 113. The first member 121 may be provided with a third guide groove, and the second member 122 may be provided with a fourth guide groove. The third guide groove and the fourth guide groove may both be hemispherical grooves. The first ball may abut against the first guide groove 1131 and the third guide groove, respectively, and the second ball may abut against the second guide groove 1132 and the fourth guide groove. The first spring and the second spring may be respectively sleeved on the second shaft 113 and may be respectively located on the opposite sides of the first member 121 and the second member 122. One damping structure 16 may be disposed corresponding to between the first spring and a first connection member 111, and the other damping structure 16 may be disposed corresponding to between the second spring and the other first connection member 111.

The support assembly 13 may include: a first support member 132 and a second support member 133. The first support member 132 may include a plurality of first sub-support members 1321 hinged in sequence, and the second support member 133 may include a plurality of second sub-support members 1322 hinged in sequence. The plurality of first sub-support members 1321 and the plurality of second sub-support members 1322 may be hinged correspondingly such that the first support member 132 and the second support member 133 form a mesh and are able to be extended or shortened after relative rotation. The corresponding ends of the first support member 132 and the second support member 133 may be respectively connected to the first member 121 and the second member 122, and the corresponding other ends of the first support member 132 and the second support member 133 may both be connected to the second connection member 131. The second connection member 131 may be used to connect to the first display device 221 of the display terminal of the notebook computer.

The slide rail assembly 14 may be slidably connected with the second connection member 131. The slide rail assembly 14 may be provided with a first boss 141 and a second boss 142 near the first rotation assembly 11. One first sub-support member 1321 connected to the first member 121 may be connected with a first stopper 151 at one end away from the first member 121, and one second sub-support member 1322 connected to the second member 122 may be connected with a second stopper 152 at one end away from the second member 122. After the support assembly 13 is shortened, the first stopper 151 and the second stopper 152 may respectively abut against the first boss 141 and the second boss 142.

In the process that the second rotation assembly 12 rotates relative to the first rotation assembly 11 to increase the angle between the first display device 221 and the system terminal, the first display device 221 may rise relative to the system terminal, the first spring and the second spring may be compressed, and the damping structures 16 may provide resistance, such that the angle between the first display device 221 and the system terminal is maintained at the increased position.

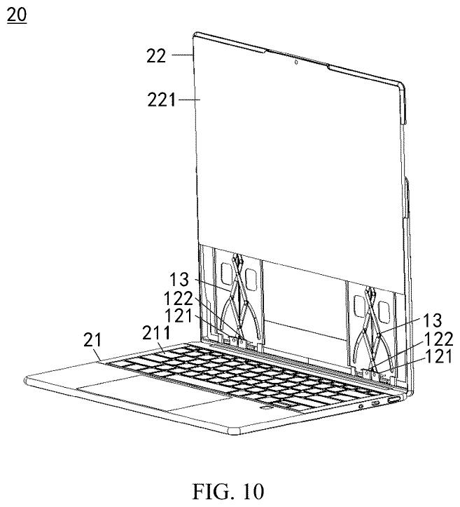

The present disclosure also provides an electronic device 20. As shown in FIG. 10 to FIG. 16, the electronic device 20 includes: a first body 21, a second body 22 and a connection device 10 provided by any embodiment of the present disclosure. The first body 21 may include an input device 211; the second body 22 may include a first display device 221. A first connection member 111 of the connection device 10 may be used to connect with the first body 21, and a second connection member 131 of the connection device 10 may be used to connect with the first display device 221 of the second body 22. Therefore, when the second connection member 131 moves relative to the first connection member 111, the first display device 221 may move relative to the second body 22 to be displaced.

The electronic device 20 may be an electronic device that is able to be folded, such as, a laptop computer, a folding mobile phone, a folding screen mobile phone with a first display screen and a second display screen, or a folding computer.

Exemplarily, in one embodiment, the electronic device 20 may be a laptop computer, the first body 21 may be a system terminal including the input device 211 on the laptop computer, the second body 22 may be a display terminal including the first display device 221, the first connection portion 111 of the connection device 10 may be connected to the first body 21, and the second connection portion 131 may be connected to the first display device 221 of the second body 22. Therefore, when the second body 22 rotates relative to the first body 21, the first display device 221 may rise relative to the second body 22, such that the user does not need to lower his head to watch the content displayed on the first display device 221 when the user uses the laptop computer, thereby reducing the probability of cervical fatigue of the user and reducing the probability of affecting the user's physical health. Further, because of the lifting of the position of the first display device 221, the contact area between the electronic device 20 and the air may be increased, thereby improving the heat dissipation efficiency of the electronic device 20.

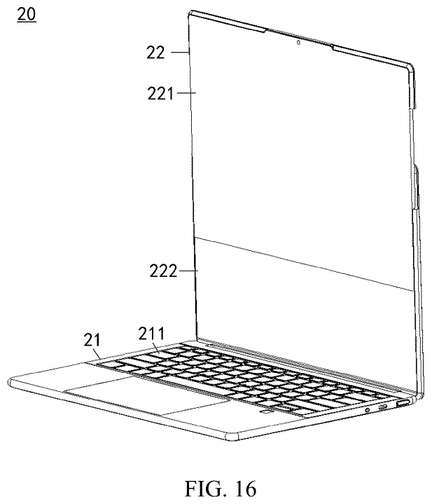

In some embodiments, as shown in FIG. 16, the second body 22 further includes a second display device 222. When the electronic device 20 is in the first state, the orthographic projection of the first display device 221 along its thickness direction may at least partially cover the second display device 222. When the electronic device 20 is in the second state, the display surface of the first display device 221 and the display surface of the second display device 222 may meet the coplanar condition. That is, the second display device 222 may be hidden behind the first display device 221, and, after the second body 22 rotates relative to the first body 21 to make the first display device 221 rise, the second display device 222 may be exposed and coplanar with the first display device 221, such that the display surface of the first display device 221 and the display surface of the second display device 222 cooperate to form a larger display surface, thereby increasing the display area of the electronic device 20. When switching from the first state to the second state, the first display device 221 may be displaced in the thickness direction of the second body 22 after the second display device 222 is fully exposed, such that the display surface of the first display device 221 and the display surface of the second display device 222 are coplanar. Or, when switching from the first state to the second state, the first display device 221 may be displaced in the thickness direction of the second body 22 after the second display device 222 is fully exposed, so that the display surface of the first display device 221 and the display surface of the second display device 222 are coplanar.

The connection device in the electronic device provided in the embodiments of the present disclosure is similar to the description of the connection device embodiments in the above, and has similar beneficial effects as the connection device embodiments in the above. For the technical details not disclosed in the electronic device embodiments of the present disclosure, references may be made to the description of the connection device embodiments, and no further description is given here.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A connection device comprising:
a first rotation assembly, including a first connection member;
a second rotation assembly, rotatably connected to the first rotation assembly and configured to rotate relative to the first rotation assembly to cause relative displacement between a first member and a second member of the second rotation assembly; and
a support assembly connected to the first member and the second member, and including a second connection member, the second connection member being configured to move relative to the first connection member when the second rotation assembly rotates relative to the first rotation assembly.

2. The connection device according to claim 1, wherein:
the first rotation assembly includes a shaft;
a first guide slope and a second guide slope are provided at a circumference of the shaft and distributed along an axial direction of the shaft;
the first guide slope and the second guide slope are both inclined with respect to the axial direction;
the first member and the second member are rotatably mounted at the first shaft;
the first member abuts against the first guide slope and is configured to be displaced along the first guide slope; and
the second member abuts against the second guide slope and is configured to be displaced along the second guide slope.

3. The connection device according to claim 2, wherein:
the shaft is provided with a limit recess connected to the first guide slope;
the first guide slope and the limit recess are distributed along the circumference of the shaft; and
the first member is provided with a limit protrusion corresponding to the limit recess.

4. The connection device according to claim 2, wherein:
the shaft is provided with a limit recess connected to the second guide slope;
the second guide slope and the limit recess are distributed along the circumference of the shaft; and
the second member is provided with a limit protrusion corresponding to the limit recess.

5. The connection device according to claim 2, wherein:
a third guide slope and a fourth guide slope are provided at the circumference of the first shaft and distributed along the axial direction of the shaft;
the third guide slope and the fourth guide slope are located between the first guide slope and the second guide slope;
the third guide slope is inclined in an opposite direction to the first guide slope, and the fourth guide slope is inclined in an opposite direction to the second guide slope;

6. The connection device according to claim 5, wherein:
an end of the first member away from the first guide slope is configured to abut against the third guide slope; and
an end of the second member away from the second guide slope is configured to abut against the fourth guide slope.

7. The connection device according to claim 2, wherein:
the second rotation assembly further includes a torsion member rotatably mounted at the shaft and including a third connection member; and
a friction between the torsion member and the shaft is greater than a friction between the shaft and any one of the first member and the second member.

8. The connection device according to claim 7, wherein the torsion member is provided with a third connection member.

9. The connection device according to claim 1, wherein:
the first rotation assembly includes a shaft,
a first guide and a second guide groove are provided at a circumference of the shaft and distributed along an axial direction of the shaft;
the first member and the second member are rotatably sleeved on the shaft;
the first member is provided with a third guide groove, and the second member is provided with a fourth guide groove;
one of the third guide groove and the first guide groove extends spirally in the axial direction of the shaft; and
one of the fourth guide groove and the second guide groove extends spirally in the axial direction of the shaft.

10. The connection device according to claim 9, wherein the second rotation assembly further includes:
a first ball abutting against the first guide groove and the third guide groove; and
a second ball abutting against the second guide groove and the fourth guide groove.

11. The connection device according to claim 1, wherein:
the first member and the second member of the second rotation assembly are configured to move relative to each other in a first direction to generate a first displacement, the first direction and the axis direction of the first rotation assembly meeting a parallel condition;
the support assembly is configured to move relative to an axis of the first rotation assembly in a second direction to generate a second displacement not less than the first displacement, the second direction and the axis direction of the first rotation assembly meeting a perpendicular condition; and
the support assembly is further configured to convert the first displacement in the first direction into the second displacement in the second direction.

12. The connection device according to claim 11, wherein:
the support assembly includes a first support member and a second support member;
the first support member includes a plurality of first sub-support members hinged in sequence;
the second support member includes a plurality of second sub-support members hinged in sequence; and
the plurality of first sub-support members and the plurality of second sub-support members are hinged correspondingly to each other such that the first support member and the second support member form a network and extend or shorten after relative rotation.

13. The connection device according to claim 12, wherein:
corresponding ends of the first support member and the second support member are respectively connected to the first member and the second member; and
corresponding other ends of the first support member and the second support member are connected to the second connection member.

14. An electronic device comprising:
a first body including an input device;
a second body including a display device; and
a connection device including:
a first rotation assembly, including a first connection member connected to the first body;
a second rotation assembly, rotatably connected to the first rotation assembly and configured to rotate relative to the first rotation assembly to cause relative displacement between a first member and a second member of the second rotation assembly; and
a support assembly connected to the first member and the second member, and including a second connection member connected to the display device, the second connection member being configured to move relative to the first connection member when the second rotation assembly rotates relative to the first rotation assembly.

15. The electronic device according to claim 14, wherein:
the display device is a first display device;
the second body further includes a second display device;
when the electronic device is in a first state, an orthographic projection of the first display device along a thickness direction of the first display at least partially covers the second display device; and
when the electronic device is in a second state, a display surface of the first display device and a display surface of the second display device meet a coplanar condition.

16. The electronic device according to claim 14, wherein:
the first rotation assembly includes a shaft;
a first guide slope and a second guide slope are provided at a circumference of the shaft and distributed along an axial direction of the shaft;
the first guide slope and the second guide slope are both inclined with respect to the axial direction;
the first member and the second member are rotatably mounted at the first shaft;
the first member abuts against the first guide slope and is configured to be displaced along the first guide slope; and
the second member abuts against the second guide slope and is configured to be displaced along the second guide slope.

17. The electronic device according to claim 16, wherein:
the shaft is provided with a limit recess connected to the first guide slope;
the first guide slope and the limit recess are distributed along the circumference of the shaft; and
the first member is provided with a limit protrusion corresponding to the limit recess.

18. The electronic device according to claim 16, wherein:
the shaft is provided with a limit recess connected to the second guide slope;
the second guide slope and the limit recess are distributed along the circumference of the shaft; and
the second member is provided with a limit protrusion corresponding to the limit recess.

19. The electronic device according to claim 16, wherein:
a third guide slope and a fourth guide slope are provided at the circumference of the first shaft and distributed along the axial direction of the shaft;
the third guide slope and the fourth guide slope are located between the first guide slope and the second guide slope;
the third guide slope is inclined in an opposite direction to the first guide slope, and the fourth guide slope is inclined in an opposite direction to the second guide slope;

20. The electronic device according to claim 19, wherein:
an end of the first member away from the first guide slope is configured to abut against the third guide slope; and
an end of the second member away from the second guide slope is configured to abut against the fourth guide slope.
